(19) United States
(12) Patent Application Publication
(10) Pub. No.: US 2018/0229251 A1
(43) Pub. Date: Aug. 16, 2018

(54) SMART WASH

(71) Applicant: James A. Duffus, III, Eden, WI (US)

(72) Inventor: James A. Duffus, III, Eden, WI (US)

(21) Appl. No.: 15/433,551

(22) Filed: Feb. 15, 2017

(51) Int. Cl. B05B 7/24; E03C 1/046; B05B 7/32; B05B 1/18

(52) U.S. Cl. CPC B05B 7/2443; E03C 1/046; B05B 7/00; B05B 1/18; B05B 7/32

(57) ABSTRACT

This invention relates to a device dispensing a solution of liquid additive with water through a shower faucet, having a head of shower faucet adapted for dispensing solution of liquid additive with water through an outlet passage. A liquid additive container has at least one compartment filled with a liquid additive and operably coupled to a main inlet tube of shower faucet to be and also to a suction tube configured on the liquid additive container for impelling the liquid additive into main inlet tube. The control of flow rate of liquid additive into main inlet tube is done by a control box operably coupled to dispensing device and main inlet tube and controls the amount and passage of liquid additive to be incorporated into main inlet tube and also capable of controlling plurality of liquid additive containers.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

### (1) Field of the Invention

The present invention relates to the field of a liquid additive dispensing assembly with a shower faucet and more particularly relates to a liquid additive dispensing and controlling assembly installed prior to the head of the shower faucet.

### (2) Background of the Invention

In recent years, a number of devices are available for liquid additive dispensed with a fresh water stream while taking bath. The need for a convenient means for dispensing soap or any other liquid additive in showers has led to sometimes creating complex manufacturing problems and to difficulties in installation. A substantial number of devices have been developed over a period of years, which are directed at the provision of a practical means of introducing a liquid additive such as soap into the water stream flowing through a shower head assembly. To date, there has been no such system which has been sufficiently practiced to be brought into common use.

In conventional liquid additive dispensing devices with a conventional shower faucet are designed for allowing, soap to be dispensed directly into the water inlet stream. Virtually the entire prior art devices suffer the characteristic that they add significant length and downward drop to the shower pipe, thereby placing the shower head at a lower than optimum position. The devices found in the prior art do not provide the convenience, flexibility and economy, which is sought by consumers, and accordingly have been commercially unsuccessful.

There have been a number of solutions provided for effective flow of water with a liquid additive through the conventional shower faucet and few of them have been discussed below:

U.S. Patent appl. No. 20080169359 A1 discloses a showerhead enables a user to selectively mix a liquid such as soap, conditioner or body wash with water. A shower stem connector, a mixing chamber, and an outlet cap direct water flow. A manual pump and liquid container enable mixing of a liquid such as soap into the water flow.

U.S. Patent appl. No. 20100213279 A1 relates to a user programmable dispenser for dispensing and mixing soap, shampoo or other liquids from a container to a mixer to be mixed with water flowing to a shower spray nozzle. A touch screen LCD display connected to a programmable controller is used by the user to first program the amount of time that the soap, shampoo or other liquids is to flow through a valve and be mixed with the water flowing from the shower spray nozzle, then is used to temporarily interrupt and recommence the flow of liquid, and is also used to display the amount of time remaining for the flow of the soap, shampoo or other liquids from the container of the time initially programmed by the user for the flow of liquid from the container to the mixer.

U.S. Pat. No. 8,800,891 B2 describes a shower soap dispenser containing a water pipe for guiding shower water to a shower head from a water supply pipe, a shower soap cartridge fixed on a pipe joint of the water pipe, and an on/off valve installed on the water pipe. The water pipe includes two feeding holes for guiding soap liquid in the pipe joint into the water pipe to further mix the soap liquid with shower water. The shower soap cartridge, including a body, a seal element fixed in the body, a plug, a cover, and a resilient element. The soap liquid is stored between the seal element and the plug. Thereby, the resilient element indirectly acts on the seal element to produce a self-sealing effect and is removed from the water pipe randomly, and soap liquid in the shower soap cartridge will not leak. Accordingly, different shower soap cartridges are capable of being removed or replaced.

The aforesaid documents and other similar solutions may strive to provide an effective flow of water with a liquid additive through the conventional shower faucet; however, they still have a number of limitations and shortcomings such as, but not limited to, incapable to connect the plurality of liquid additive containers. Further, the use of sensors with the user desired predetermined time and amount of liquid additive in the water streaming are not included in the prior art. The above mentioned prior arts can only perform certain aspects say for example, provides an assembly for dispensing a stream of water with a liquid additive. In general, these methods involve intercepting the stream of water with a liquid additive without any user control streaming.

Accordingly, there remains a need in the prior art to have an improved liquid additive dispensing assembly with a conventional shower faucet, and a dispensing assembly, primarily for use in a shower, which incorporates a stream of pressurized water and a liquid additive in a user defined proportions.

### SUMMARY OF THE INVENTION

In the view of the foregoing limitations inherent in the known types of liquid additive dispensing devices now present in the prior arts, the present invention provides an improved dispensing assembly with shower faucets. As such, the general purpose of the present invention, which will be described subsequently in greater detail, is to provide a new and improved liquid additive dispensing assembly having a control system for controlling proportional liquid additive into the water stream, which supersedes all the limitations of the prior arts.

Accordingly, it is a primary object of the present invention to provide a device dispensing a solution of liquid additive with water through a shower faucet including a head of shower faucet having an outlet passage for dispensing water and a liquid additive solution. A liquid additive container connected to the main inlet tube line of the shower faucet and means for monitoring and controlling flow rate of liquid additive dispensing through liquid additive container.

It is another object of the present invention to provide the means for controlling the flow rate of liquid additive by using a control box. Dispensing devices possessing only one liquid additive container, the control box designed to perform dual purpose of switching and rotating to make supply of liquid additive ON/OFF and to control the flow rate of the liquid additive respectively. The dual purpose control button can behave as a jog dial or dialer that can be rotated mechanically and can also be used as a push-pull switch. In devices having plurality of liquid additive containers the control box possessing more functionality for users and more numbers of switches to select the containers and their flow rates accordingly.

It is another object of the present invention is to provide the liquid additive dispensing assembly installed in such a manner that it can be affixed to main inlet tube by just removing the shower head and the device is affixed from its tailing terminal, and then previously removed head terminal can be again affixed to the head terminal of shower faucet resulting in an tranquil installation of the device. The liquid additive dispensing assembly can contain a plurality of containers to store a liquid additive selected from a group of soap, shampoo, conditioner, medicine, muscle relaxant, aromatherapy and the like for efficient showering experience.

It is another object of the present invention to provide the liquid additive dispensing assembly having multiple containers for storing different contents at the same time which can be selected by the user from control box.

It is another object of the present invention to provide the liquid additive container that is affixed in a manner to the main inlet tube that can be removed for refilling or inserting fresh liquid additive container.

It is another object of the present invention to provide the liquid additive dispensing assembly for affixing with the main inlet tube and the head of shower faucet in which affixing is very simple in operation.

Other objects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows a perspective view of a shower faucet with a liquid additive container according to an embodiment herein;

FIG. 2 is a schematic representation of a liquid additive dispensing assembly of the present invention;

FIG. 3 is a diagrammatic illustration of a plurality of liquid additive containers with control box;

FIG. 4 is a diagrammatic representation of another embodiment explaining the control mechanism of liquid additive containers;

FIG. 5 discloses front view and top views of the liquid additive container in one embodiment of the invention;

FIG. 6 refers to the complete assembly of the dispenser unit; and

FIG. 7 illustrates a switch of the shower head according to an embodiment herein.

### DETAILED DESCRIPTION OF THE INVENTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

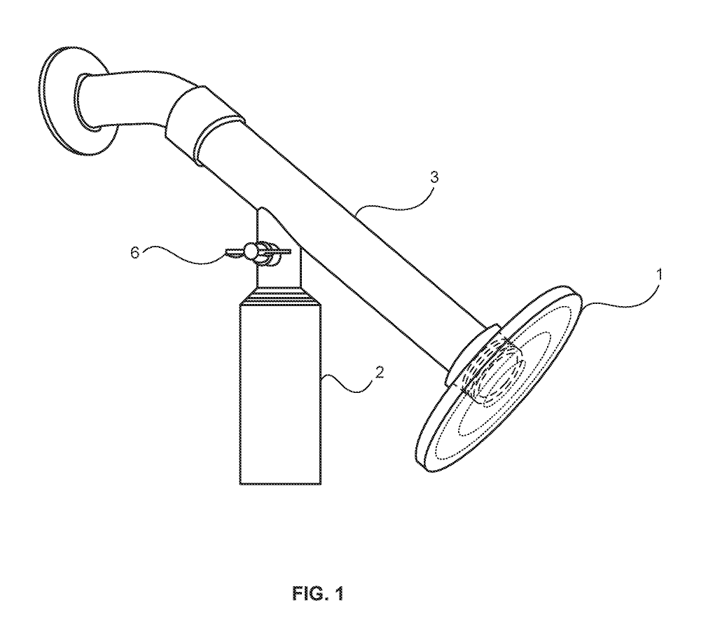

FIG. 1 shows a perspective view of a shower faucet (1) with a liquid additive container (2) according to an embodiment herein. The liquid additive container (2) contains one or more soap solutions. The liquid additive container (2) couples to the shower faucet (1) with a main inlet tube (3). A control box (6) regulates the flow of the liquid additive from the liquid additive container (2).

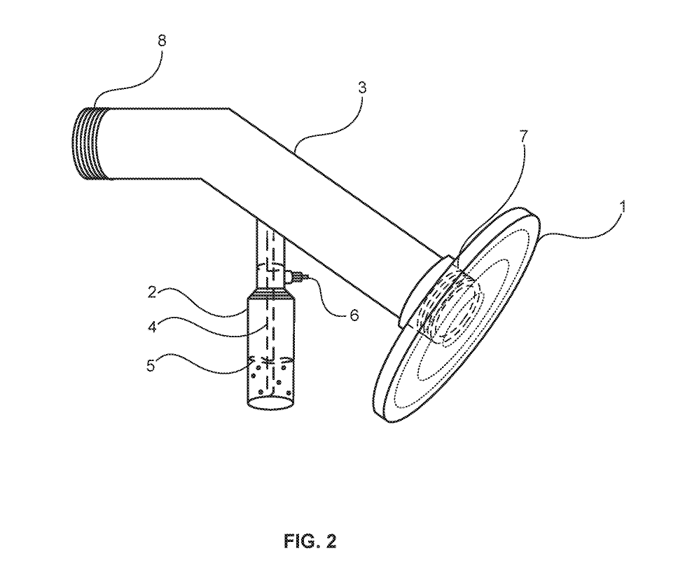

Referring to FIG. 2, the present invention generally provides a device dispensing a solution of liquid additive (5) with water through a head of conventional shower faucet (1). A liquid additive container (2), coupled to a main inlet tube (3) of fine diameter. The liquid additive dispensing container (2) is removably attached to the main inlet tube (3) by a coupling mechanism. The main inlet tube (3) is embedded with threads at its both ends. The tube (3) end connected to main water supply at its tail terminal having tail threading (8) outwardly and the other terminal designed to adopt shower head (1) at its head terminal having head threading (7) outwardly. The coupling mechanism can be adopted from a plurality of available coupling mechanisms and these are mechanical coupling, magnetic coupling, sleeve coupling, clamp or split muff coupling, universal joints. The coupling between these two can be achieved by threading interlocking or by other possible means also. The liquid additive dispensing container (2) adapted to be filled with plurality of liquid additives (5) selected from a soap solution, soap cartridges, conditioner, shampoo, relaxing gel, body spray, sports medicine but not limited to these only and carrying a suction tube (4) to the pump liquid additive (5) into the main inlet tube (3). The amount of flow rate of liquid additive (5) monitored and controlled by a control box (6) attached to the liquid additive dispensing container (2). The control box (6) provides the privilege to control flow rate of liquid additive (5) and for switching ON/OFF the liquid additive (5) to receive only clean water supply from the main inlet tube (3). The control box (6) operates the suction tube (4) in a manner that the suction tube (4) alters the release rate of liquid additive (5) according to user defined settings. The liquid additive container (2) of the liquid additive dispensing assembly is filled with the liquid additive (5) selected from the group of soap solution, soap cartridges, conditioner, shampoo, relaxing gel, body spray, sports medicine and a combination thereof.

The dispensing device as discussed can be easily installed on the already installed shower faucet devices in an easy way by just removing the shower head (1) of already installed shower faucet and installing this dispensing unit from its tail terminal by using its tail threading (8) to interlock the dispensing unit to direct supply and removably attaching the removed shower head (1) to the head threading (7).

The same arrangement can be installed and re-installed any number of times and provides a hassle free operation.

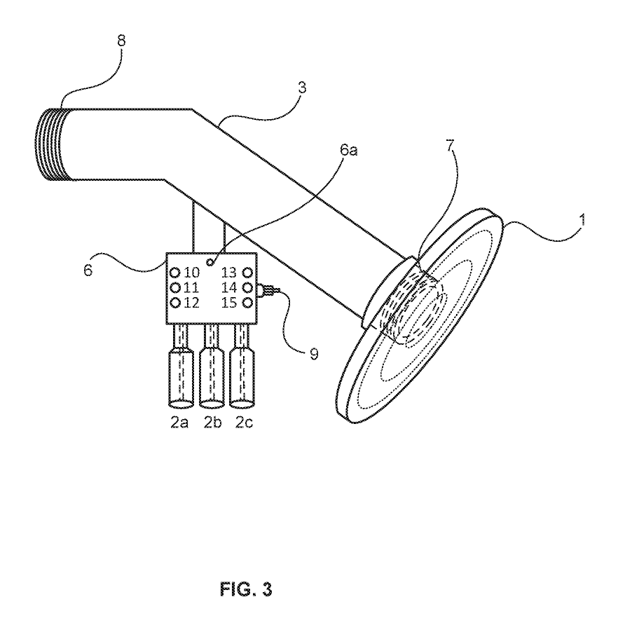

In accordance with an embodiment of the present invention, the liquid additive dispensing container with a conventional shower faucet is preferably made from synthetic plastic, hard plastic, stainless steel, injection molded plastic, although other suitable construction materials can be used. Referring now to FIG. 3, discloses a plurality of liquid additive containers 2(a), 2(b) and 2(c) carrying liquid additive according to user needs. The suction tubes of these liquid additive containers 2(a), 2(b) and 2(c) operatively coupled to the control box (6) that is configured with a plurality of control buttons to perform various functions accordingly. A dialer button (9) is provided on the control box (6) that serves the dual purpose, firstly, it allows the users to control the flow rate of liquid additive getting mixed in the water stream by rotating it in either direction and secondly, the user can restrain and/or release the supply of liquid additive into the main inlet tube (3) by simply pressing the dialer button (9) to change its state from ON/OFF accordingly. The control switches were designed to perform plurality of operations a user desires to perform according to varying needs. The number of switches can vary depending on the number of operations a user has to perform. The switches that are numbered from 10 to 12 are assigned to select liquid additive container from 2(a), 2(b) or 2(c) and the remaining switches numbered from 13 to 15 are used to perform various operations selected from clean water select switch, liquid additive select switch, liquid additive flow control switch, liquid additive container select switch, clean water flow control switch and combination thereof.

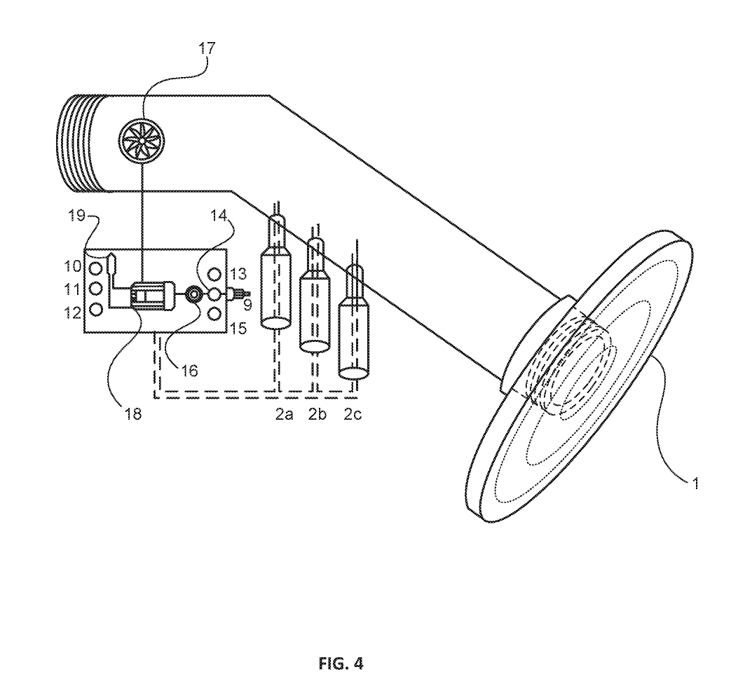

Referring now to FIG. 4, discloses a diagrammatic representation of another embodiment explaining the control mechanism of liquid additive containers 2(a), 2(b) and 2(c) respectively. In this embodiment an impeller (17) is installed in main inlet tube that receives the driving force from the flowing water stream and this system in combination with a generator (18) and a capacitor (19) resulting in a water generator, that delivers the generated energy to a motion sensor (16) which controls the pumping of suction tube fitted inside the liquid additive containers 2(a), 2(b) and 2(c) to adjust the flow rate of liquid additive. The motion sensor can also be powered by a removable battery attached to it. The capacitor used in combination with generator to store the energy and to remove noises and acts as a filter for the system.

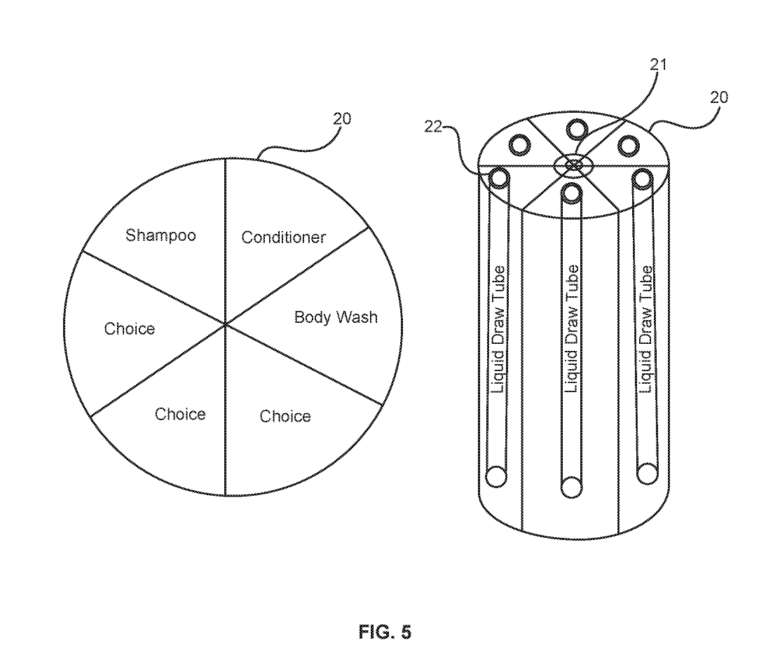

FIG. 5 discloses front view and top views of the liquid additive container (20) in one embodiment of the invention. The liquid additive container is provided with a plurality of draw tubes within a cartridge compartments, with connection seals (22) at the top. The cartridge also termed here as liquid additive container. A cylinder connection apparatus known as cartridge seal (21) is also provided to maintain a connection with the main water inlet tube. The cartridge seal (21) have a threaded center section in order to connect the cartridge to the connection plate. This connection mechanism can be achieved by using clips around the outside of the cartridge. The top view of the cartridge (20) represents a plurality of connection choices to be connected to the main inlet tube via the connection plate. The plurality of draw tubes are filled with a plurality of liquid types that includes a shampoo, conditioner, body wash, oil, body spray, colognes, perfumes, shaving cream, gel or non-water soluble products.

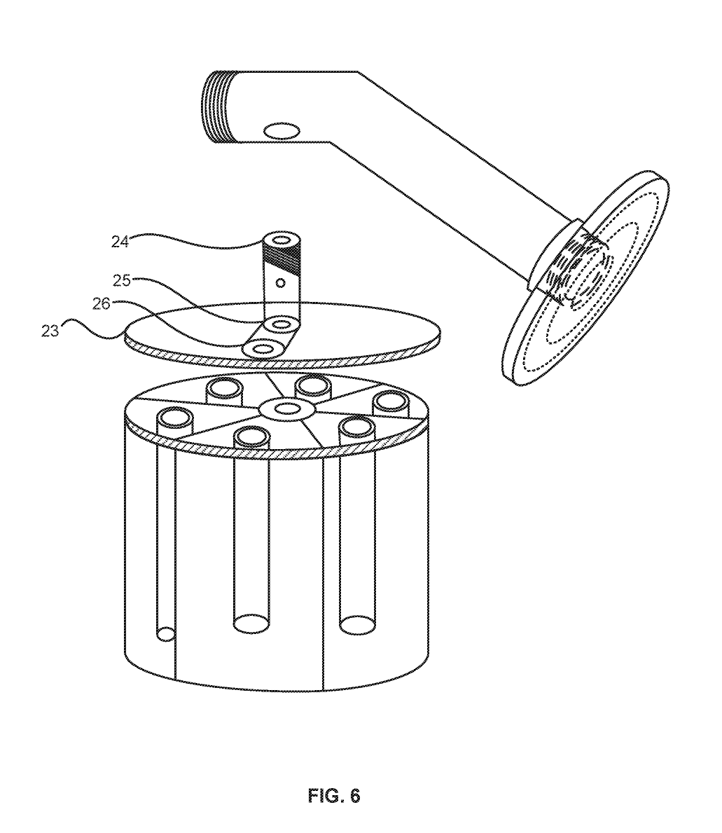

FIG. 6 refers to the complete assembly of the dispenser unit having a cartridge containing soap solution; the dispenser unit can be removably attached to the main inlet water tube. It includes a connection plate (23) that provides a connection between a cartridge and a shower pipe. The connection plate (23) having one seal (24) to establish a connection with the shower pipe and another seal (26) that meets with the cartridge seal in an appropriate compartment to allow the liquid to be drawn and dispensed. One another seal (25) is connected to the cylinder connection apparatus. In one embodiment, the connection plate (23) may be coupled to the dispenser unit using magnetic coupling, sleeve coupling or using threads. The dispensing unit includes multiple tubes carrying same/different kind of soap/shampoo. A rubber seal is provided at the top of each tube of the dispensing unit, to avoid the spillage of the soap/shampoo held by the tubes. The dispensing unit further includes an emergency stop button (27). The emergency stop button (27) includes a pin connected to the control box (6) from inside. When a user pushes the emergency stop button (27) inside, the pin stops the flow of the soap immediately, regardless of the position of a switch (not shown in FIG. 5). The user may then turn the knob (not shown in FIG. 5) of the switch to a desired flow rate mark, and pull the pin outside to allow the soap additive to flow at that desired tick mark.

In one embodiment of the invention, a single cartridge can contain a plurality of soap solution that can be dispensed accordingly.

In one another embodiment of the invention, the cartridge mechanism is adapted to rotate around the cartridge seal of the cylindrical cartridge and having a lock and release mechanism to release the appropriate soap solution from different compartments of the cartridges by locking the seal of connection plate with that of the cartridge containing soap solution.

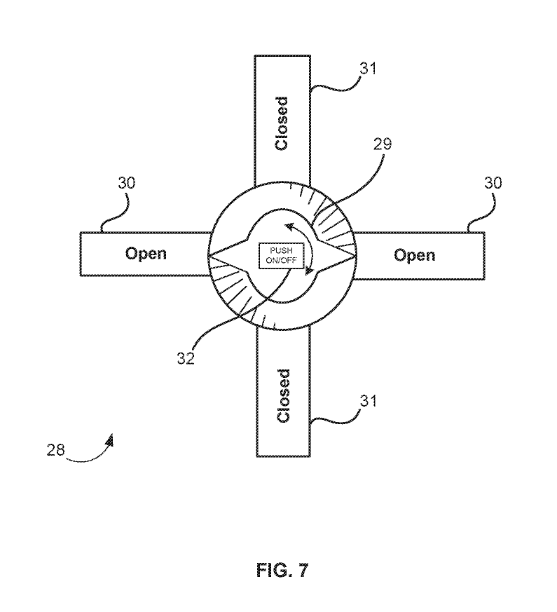

FIG. 7 illustrates a switch (28) according to an embodiment herein. The switch (28) includes a knob (29), an open mark (30), and a closed mark (31). The open mark (30) is arranged in horizontal position, and the closed mark (31) is arranged in vertical position. The knob (29) shuts the supply of the soap when a user aligns the knob (29) in vertical position. The knob (29) allows the soap to pass through when the user aligns the knob (29) in horizontal position. The flow of the soap increases slowly and gradually as the user rotates the knob (29) from the closed position to the open position. In one embodiment, a ball valve can also be used with the switch to control the flow of the soap. The marks on the switch indicate the flow rate of the liquid additive. The user may also press the knob (29) to turn the supply of the soap ON, and press the knob (29) again to turn the supply OFF. Additionally, there is ON/OFF push button (32) that turns the supply of the soap ON on pressing the push button (32) once, and turns the supply of the soap OFF on pressing the push button (32) again. In emergency cases, the push button (32) acts as a safety feature.

In one embodiment of the invention, the suction tube is incorporated in the liquid additive container for pumping a plurality of liquid additives. Further, the dialer is operated to actuate the suction tube to set the flow rate from the liquid additive container while setting down the dialer. The dialer is also operably designed to be pushed as an actuating button or switch so that the user can have a set or reset the dialer for obtaining clean water or water soap solution.

In accordance with one another embodiment of the present invention, the means for sensing of the liquid additive dispensing assembly configured to have a plurality of product selector switches. These pluralities of switches could be run by a motion sensor and/or manually. The motion sensor version the objective can be achieved with a basic water generated energy system with a tiny rotating impeller in the motion of the water stream with a small DC motor, and a capacitor to store enough energy to command the liquid additive dispensing assembly into action hence making it sufficient assembly and there is no need of any type of battery or driving external power supply.

In yet one another embodiment of the present invention, the devices holding only one liquid additive container includes a control box in the form of a rotating dial to control the flow rate of liquid additive along with a push pull type switching mechanism to ON/OFF the supply of liquid additive into main water stream. However, if the device contains plurality of liquid additive containers then the control box can also be transformed into a different form having a number of control options for users to select different containers and their flow rates etc. along with dialer button.

The above-mentioned liquid additive dispensing mechanism allows a very effective way for a liquid additive to be dispensed directly into the water inlet stream by a means for sensing with a user controlled mechanism. The present invention is intended to create a unique showering experience for the user with fewer efforts. In addition, the size and dimensions of different components of the dispensing shower faucet can be designed as per the requirement of the user in a plurality of designs. The liquid additive container that is attached to the liquid additive dispensing assembly is not limited to being a single container; alternatively, the liquid additive container can be multiple liquid additive containers that are attached to the assembly. Further, the liquid additive dispensing assembly can be easily replaced with the conventional shower faucet and very economical in use.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause these to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments only. Many variations, modifications, additions and improvements to the embodiments described above are possible. It is contemplated that these variations, modifications, additions and improvements fall within the scope of the invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. A device to dispense a solution of liquid additive with water through a shower faucet, wherein said device comprises:
a head of said shower faucet having an inlet and an outlet passages wherein said head of said shower faucet is adapted for dispensing said solution of liquid additive with water through said outlet passage;
at least one liquid additive container operably coupled to a main inlet tube of said shower faucet;
a suction tube configured on said liquid additive container wherein said suction tube impels said liquid additive into said main inlet tube; and
a control box operably coupled to said dispensing device and main inlet tube wherein said control box adaptively controls the amount and passage of said liquid additive to be incorporated into said main inlet tube, wherein said control box further comprises:
a switch that is adapted to regulate flow of said solution of liquid additive.

12. The device as claimed in claim 11, wherein said main inlet tube of dispensing device is configured to accommodate a plurality of liquid additive containers.

13. The device as claimed in claim 11, wherein said control box configured to have a plurality of control switches.

14. The device as claimed in claim 13, wherein said control switches are configured to selectively switch between user defined functions selected from clean water select switch, liquid additive select switch, liquid additive flow control switch, liquid additive container select switch, clean water flow control switch and combination thereof.

15. The device as claimed in claim 11, wherein said control box includes a motion sensor wherein said motion sensor controls dispensing of said liquid additive through said suction tube.

16. The device as claimed in claim 11, wherein said control box comprises a dial switch wherein said dial switch controls flow rate of said liquid additive in said main inlet tube.

17. The device as claimed in claim 11, wherein said control box comprises a dial switch wherein said dial switch controls flow rate of said liquid additive in said main inlet tube by adopting rotating mechanism.

18. The device as claimed in claim 11, wherein said dial switch configured to dispense and restrain said liquid additive in said main inlet tube by adopting a push pull mechanism.

19. The device as claimed in claim 11, wherein said liquid additive container includes at least one compartment filled with liquid additive.

20. The device as claimed in claim 19, wherein said liquid additive container includes a plurality of compartments.

21. The device as claimed in claim 11, wherein said liquid additive containers are made from a material selected from synthetic plastic, hard plastic, stainless steel and a combination thereof.

22. The device as claimed in claim 11, wherein said liquid additive is selected from soap solution, soap cartridges, conditioner, shampoo, relaxing gel, body spray, sports medicine and a combination thereof.
